(19) United States
(12) Patent Application Publication
(10) Pub. No.: US 2016/0259958 A1
(43) Pub. Date: Sep. 8, 2016

(54) CODE READING DEVICE

(71) Applicant: WELCAT INC., Tokyo (JP)

(72) Inventors: Seietsu Nara, Tokyo (JP); Tsuyoshi Katsuta, Tokyo (JP)

(21) Appl. No.: 14/649,775

(22) PCT Filed: Jun. 2, 2014
(86) PCT No.: PCT/JP2014/064627

§ 371 Date: Jun. 4, 2015

(30) Foreign Application Priority Data
Feb. 20, 2014 (JP) 2014-030668

(51) Int. Cl. G06K 7/10; G06K 19/06; G06K 7/14

(52) U.S. Cl. CPC G06K 7/10891; G06K 7/1447; G06K 19/06028; G06K 19/06037

(57) ABSTRACT

A code reading device (1) captures, and records as multi-value image data, a slip (4) on which a plurality of code symbols (3a, 3b) are printed, detects, as a specified position of a finger (2a), a position of the longest succession of black values in the vertical direction from the lower frame of binary image data obtained by binarizing the multi-value image data, and reads the code symbol (3a) that is present near the specified position.

### TECHNICAL FIELD

The present invention relates to a code reading device.

### BACKGROUND ART

Conventionally, there is known a code reading device that acquires information by interpreting a code symbol such as a one-dimensional barcode or a two-dimensional barcode. In recent years, as such a code reading device, a so-called wearable code reading device that may be attached to a part of the body of a user so as to allow the user to not have to switch the hand holding the device body and to use both hands is being developed.

For example, Patent Document 1 discloses a portable code reading device configured by mounting a two-dimensional image capturing unit for capturing a two-dimensional area including a code symbol which is the target of reading on a part of the body of a user, such as the head, shoulder, wrist or hip. Moreover, the code reading device of Patent Document 1 is also capable of projecting aiming light from the two-dimensional image capturing unit so as to allow viewing of the capturing range by eye.

### PRIOR ART DOCUMENT

### Patent Document

Patent Document 1: Japanese Patent No. 3020943

### SUMMARY OF THE INVENTION

### Problems to be Solved by the Invention

However, in the case of attaching an image capturing unit to a part of the body as described in Patent Document 1, the part of the body where the image capturing unit is attached has to be adjusted at the time of capturing, by being moved to the target capturing range or by having the direction changed, for example. In the case of attaching the image capturing unit to the wrist as described in Patent Document 1, for example, the direction of the hand or the arm has to be adjusted so that the aiming light flashes the code symbol. Also, one has to clench his/her hand or withdraw his/her arm so as not to shade the capturing area or the aiming light.

Furthermore, in the case where there are a plurality of code symbols on a slip or the like, and where one of the code symbols is to be read, the capturing area of the code reading device has to be precisely adjusted by using the aiming light or the like so that the corresponding code symbol is captured.

As described above, even with a wearable code reading device, there is a problem that the hand or the arm has to be moved irrespective of its true purpose in order to capture a code symbol, and the operability is not always improved.

The present invention is made to solve such a problem, and an object of the present invention is to provide a code reading device capable of allowing specification and reading of a code symbol which is the target of reading by a natural movement, and of improving operability.

### Means for Solving the Problems

In order to achieve the above object, a code reading device according to the present invention includes an image capturing unit for capturing an image including a code symbol, a specified position detection unit for analyzing image data captured by the image capturing unit, and detecting a specified position specified by a specifying object within the image data, a code extraction unit for extracting, as a target of reading, a code symbol that is present near the specified position detected by the specified position detection unit, and a code decoding unit for decoding the code symbol extracted by the code extraction unit.

### Advantageous Effects of the Invention

According to the present invention using the means described above, a code symbol which is the target of reading may be specified by a natural movement and be read, and the operability may be improved.

### BRIEF DESCRIPTION OF THE DRAWINGS

FIG. 1 is an external configuration diagram of a state where a code reading device according to an embodiment of the present invention is mounted on the wrist of a user.

FIG. 2 is a block diagram showing a configuration of the code reading device according to an embodiment of the present invention.

FIG. 3A is an explanatory diagram regarding size of image data.

FIG. 3B is an explanatory diagram regarding coordinates of image data.

FIG. 3C is an explanatory diagram regarding example values of respective coordinates at the time of fingertip detection.

FIG. 4 is an explanatory diagram showing an example of binary image data and successive black-value length from the lower frame of the image.

FIG. 5 is a flow chart showing an operation of a code reading device according to an embodiment of the present invention.

FIG. 6 is an external configuration diagram of a state where a code reading device according to an example modification of the present invention is mounted on the wrist of a user.

### MODE FOR CARRYING OUT THE INVENTION

Hereinafter, a code reading device according to the present invention will be described with reference to the drawings.

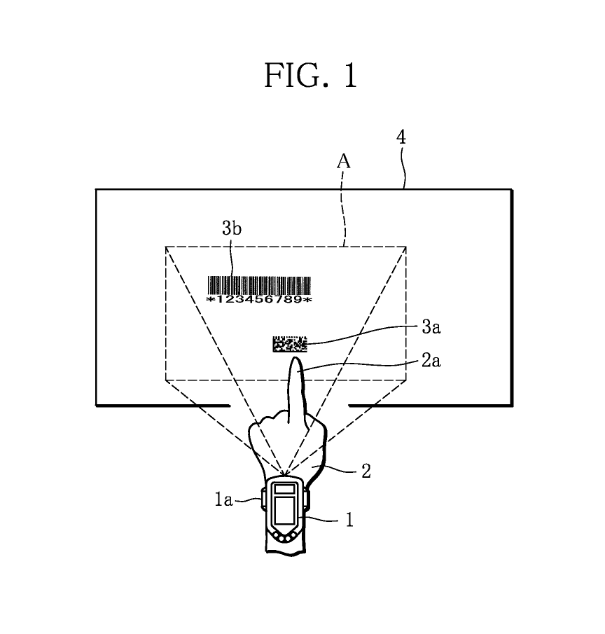

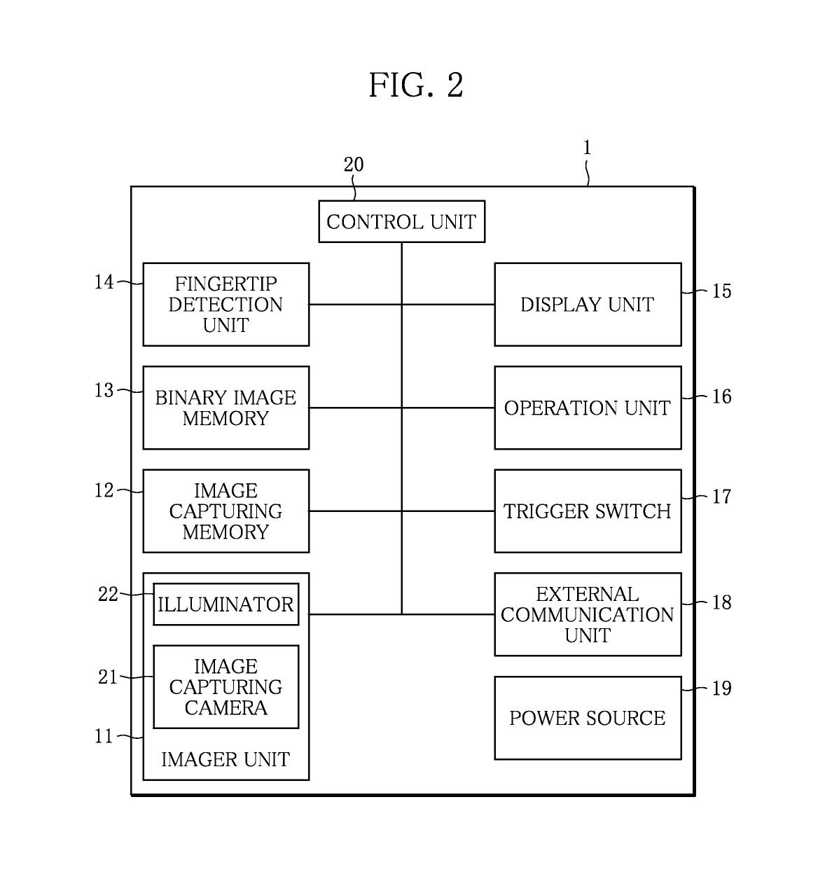

FIGS. 1 and 2 show a configuration of a code reading device according to an embodiment of the present invention.

As shown in FIG. 1, a code reading device 1 according to the present embodiment is a so-called wearable code reading device that is to be mounted on the wrist of a user, on the backside of the hand, by a mounting tool 1a such as a belt. The code reading device 1 is for capturing a slip 4 on which a plurality of code symbols 3a and 3b shown in FIG. 1, for example, are printed, identifying, as a specifying object, a finger 2a of a hand 2 on which the code reading device 1 is mounted, and reading the code symbol 3a near the tip of the finger 2a.

As shown in FIG. 2, the code reading device 1 mainly includes an imager unit 11, an image capturing memory 12, a binary image memory 13, a fingertip detection unit (a specified position detection unit) 14, a display unit 15, an operation unit 16, a trigger switch (a trigger unit) 17, an external communication unit 18, a power source 19, and a control unit 20. Units other than the power source 19 are mutually connected in a manner capable of data communication.

Specifically, the imager unit 11 includes an image capturing camera 21 (an image capturing unit) for capturing an image including a code symbol, and an illuminator 22. The image capturing camera 21 is a two-dimensional camera that uses a COMS sensor, for example, and as shown by the broken line in FIG. 1, captures a rectangular capturing range in one direction of the code reading device 1. The illuminator 22 projects light in the same direction as the capturing direction of the image capturing camera 21 and illuminates the capturing range so as to allow the image capturing camera 21 to clearly capture the code symbol even in a dark place, for example.

The image capturing memory 12 is a part for storing multi-value image data captured by the imager unit 11.

The binary image memory 13 is a part for storing binary image data that is obtained by binarization of multi-value image data stored in the image capturing memory 12 by using a predetermined threshold. Additionally, in the present embodiment, binary image data having two values, white value and black value, is used.

As will be described later in detail, the fingertip detection unit 14 is a part for detecting the tip of the finger 2a within the binary image data as a specified position.

The display unit 15 is a part for displaying, so as to allow viewing by a user, a guide to an operation menu of the code reading device 1, or the state of the code reading device 1, a code reading result or the like in the form of letters, diagrams or the like.

The operation unit 16 is a touch panel, a switch or the like, for example, and is a part for allowing a user to perform a selection/instruction operation according to display on the display unit 15, or to input information, for example.

The trigger switch 17 is a switch for instructing that capturing by the imager unit 11 is to be started, and in the present embodiment, is a push-button switch provided to the code reading device 1.

The external communication unit 18 is for performing communication between the code reading device 1 and an external computer device or the like. The communication method of the external communication unit 18 is not particularly limited, and it may be a wired, infrared or wireless method, for example.

The power source 19 is a primary battery or a secondary battery, and is a power source for operating the code reading device 1. Additionally, a structure where power is supplied from outside is also possible.

The control unit 20 is configured from a CPU for performing arithmetic processing at the code reading device 1, and performs operation control according to the programs such as basic software and application software. For example, the control unit 20 converts multi-value image data stored in the image capturing memory 12 into binary image data, and stores the same in the binary image memory 13. Furthermore, the control unit 20 extracts a code symbol existing near a fingertip position detected by the fingertip detection unit 14 as a target of reading (a code extraction unit), decodes the code symbol (a code decoding unit), and displays the decoding result on the display unit 15, or transmits the same to an external computer via the external communication unit 18.

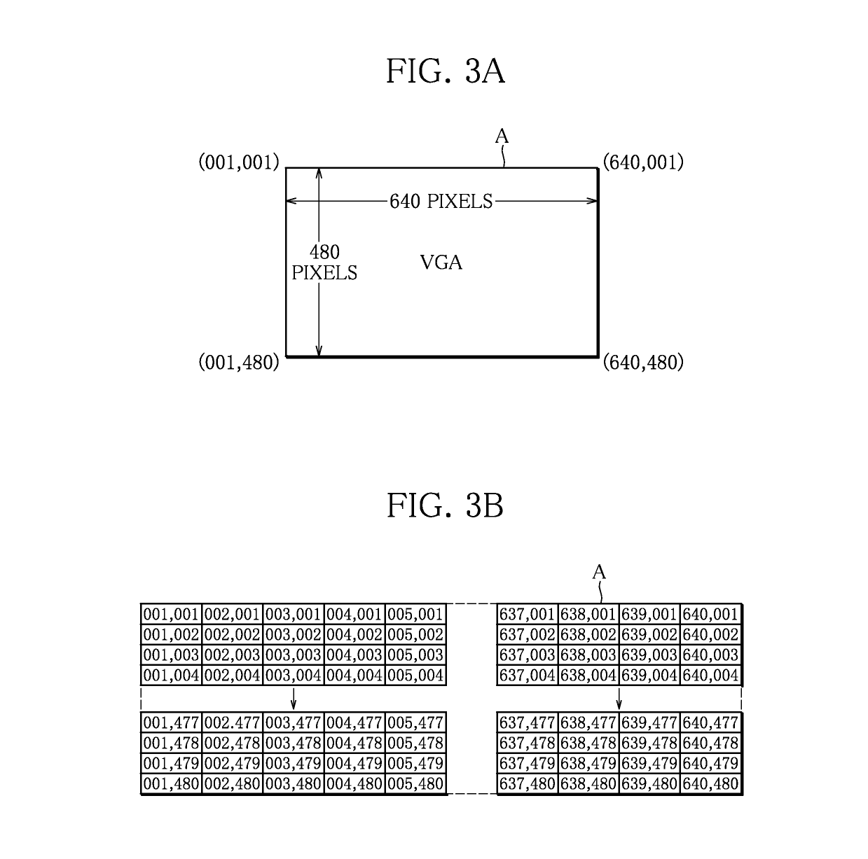

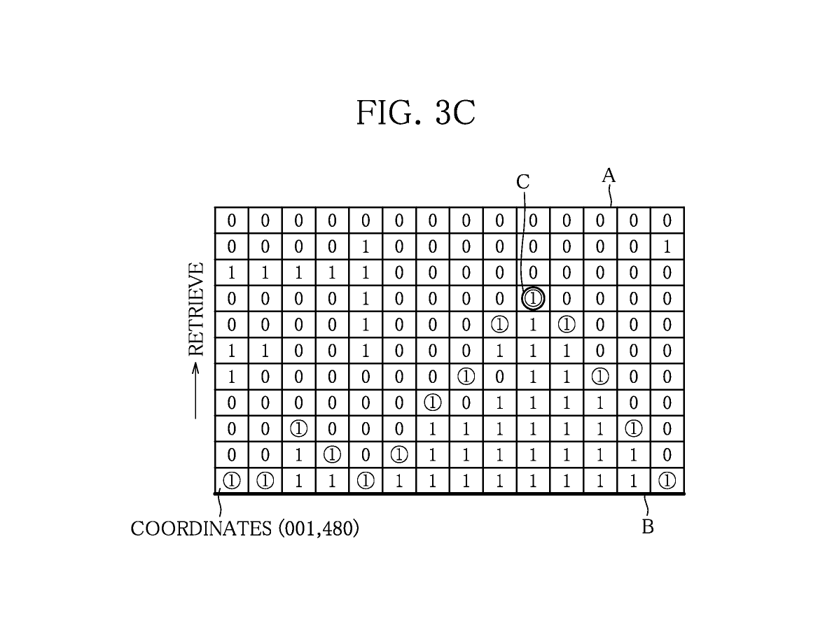

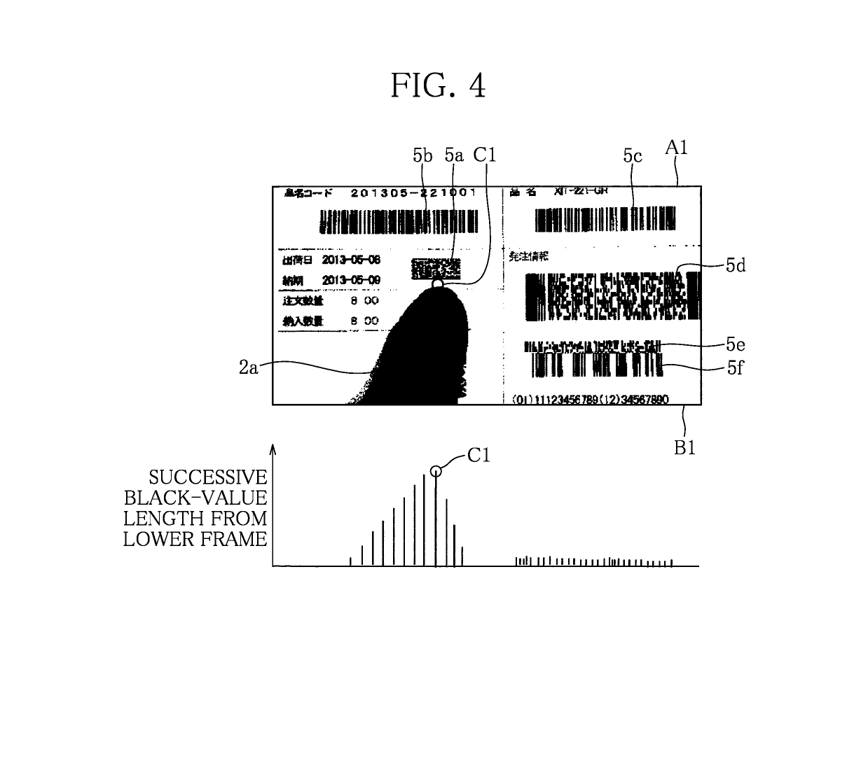

Now, a fingertip detection method of the fingertip detection unit 14 will be described in detail. FIGS. 3A to 3C show explanatory diagrams for conversion into binary image data, and FIG. 4 shows an example of binary image data and successive black-value length from the lower frame of the image, and description will be given below with reference to these drawings.

First, as shown in FIG. 3A, binary image data that is saved in the binary image memory 13 has coordinates given to each pixel, as shown in FIG. 3B, with the horizontal direction as the X-axis, the vertical direction as the Y-axis, and the upper left end as (001, 001) when the size of image data to be captured by the image capturing camera 21 is so-called VGA size of horizontally (in width) 640 pixels and vertically (in height) 480 pixels, for example. Also, as shown in FIG. 3C, the binary image data has a value 0 input to the coordinates of a part with a white value and a value 1 input to the coordinates of a part with a black value.

The fingertip detection unit 14 sets a predetermined reference line in advance in such binary image data A, and retrieves the black value along the vertical direction from the reference line. In the present embodiment, the predetermined reference line is set to a lower frame B, and successive black values are retrieved from the coordinates (001, 480) of the lower left end toward the upper end. Also, in the present embodiment, it is determined that there is a discontinuity in the black values when there are two successive white values, for example, and the length from the lower frame B to the discontinuity in the black values is taken as the successive black-value length. When the successive black-value length of the left end column is settled, the retrieval is performed in the same manner with respect to the successive black-value length for the column that is adjacent on the right, and thereafter, the retrieval is performed with respect to the successive black-value length for each column in the horizontal direction. Then, when the successive black-value length of each column is settled, the fingertip detection unit 14 detects the upper end position of the longest successive black-value length as a fingertip position C.

Specifically, when referring to FIG. 4, one-dimensional codes and two-dimensional codes are present in binary image data A1 in a mixed manner, and a plurality of code symbols 5a to 5f are captured, and the finger 2a is also shown up. The fingertip detection unit 14 retrieves the successive black-value length from a lower frame B1 of the binary image data A1, and detects the upper end of the longest successive black-value length as a fingertip position C1. Then, the control unit 20 extracts the code symbol 5a nearest to the fingertip position C1 as the target of reading, and performs decoding thereof.

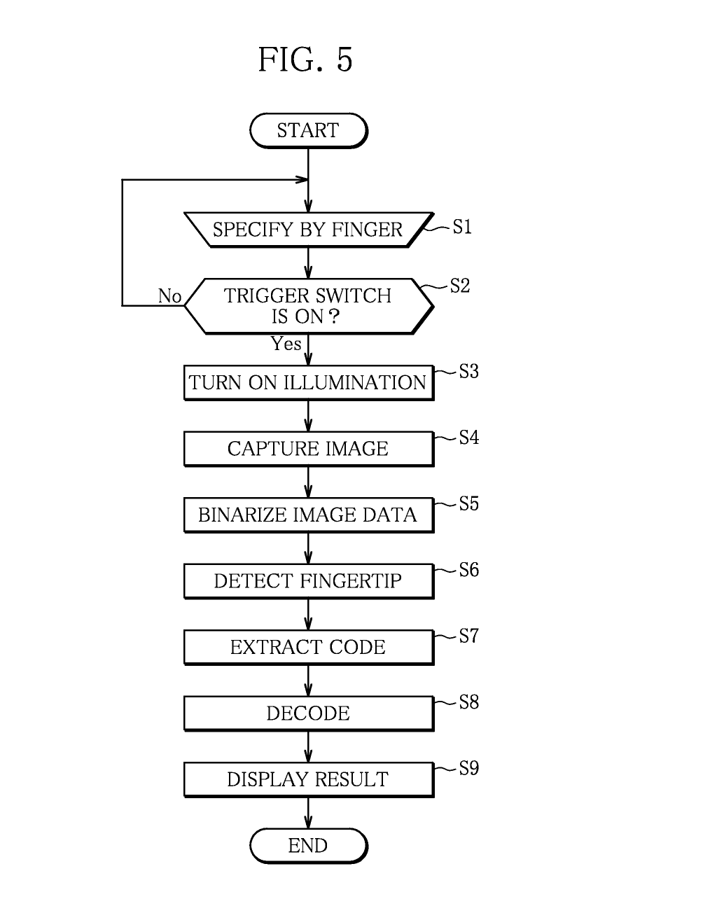

Now, an operation flow of code reading by the code reading device 1 is shown in FIG. 5, and the operation procedure of the code reading device 1 of the present embodiment will be described below according to the flow.

First, as shown in step S1 in FIG. 5, a user wearing the code reading device 1 on the wrist by the mounting tool 1a specifies the target of reading by bringing a fingertip close to within a code symbol which is the target of reading or to a marginal portion near the code symbol. At this time, the finger may be or not be in contact with the slip.

Then, in step S2, the control unit 20 of the code reading device 1 determines whether the trigger switch 17 is in an ON state or not. In the case where the trigger switch 17 is not operated and is in an OFF state, the determination result will be false (No), and the process will be returned to step S1. On the other hand, in the case where the trigger switch 17 is operated and is in an ON state, the determination result will be true (Yes), and the process will proceed to step S3.

In step S3, the control unit 20 turns on the illuminator 22 of the imager unit 11, and in the subsequent step S4, an image including the code symbol is captured by the image capturing camera 21 of the imager unit 11, and is stored in the image capturing memory 12 as multi-value image data (an image capturing step).

Next, in step S5, the control unit 20 converts the multi-value image data stored in the image capturing memory 12 into binary image data, and saves the same in the binary image memory 13.

The finger 2a may be easily detected by the code reading device 1 by the captured multi-value image data being binarized and detection being performed based on the vertical successive length from the lower frame of the black values corresponding to the finger 2a.

Particularly, in the case of mounting the code reading device 1 on the wrist on the backside of the hand as in the present embodiment, detection of the finger 2a may be performed by a simple analysis by retrieval of only the vertical black-value length from the lower frame B of the binary image data A which has been binarized.

In step S6, the fingertip detection unit 14 detects the fingertip position by the method described above based on the binary image data stored in the binary image memory 13 (a specified position detection step).

In step S7, the control unit 20 extracts the code symbol that is present near the fingertip position detected by the fingertip detection unit 14 (a code extraction step).

Additionally, in the case where a code symbol which is the target of reading cannot be extracted due to a finger overlapping a part of the code symbol, for example, the control unit 20 performs extraction when extraction of the entire region of the code symbol becomes possible due to the finger being bent or moved. Therefore, in the case of specifying the target of reading by bringing a fingertip close to a code symbol, the user preferably performs a movement of bending the finger immediately after the specifying movement. By allowing specification of the target of reading by bringing a fingertip close to a code symbol, a barcode may be appropriately specified even when barcodes are densely present and there is not much marginal space.

Furthermore, the control unit 20 decodes the extracted code symbol in step S8 (a decoding step), and in step S9, displays the decoding result on the display unit 15 or transmits the same to an external computer via the external communication unit 18, for example, and then ends the operation flow.

As described above, with the code reading device 1 according to the present embodiment, because the finger 2a of the user, whose appearance is usually not desirable, is identified as a specifying object, the user is enabled to specify a code symbol which is the target of reading by a natural movement of pointing to the code symbol by the finger 2a.

Also, as described above, the finger 2a may be easily detected by the code reading device 1 by the captured multi-value image data being binarized and detection being performed based on the vertical successive length from the lower frame of the black values corresponding to the finger 2a. Particularly, in the case of mounting the code reading device 1 on the wrist on the backside of the hand as in the present embodiment, detection of the finger 2a may be performed by a simple analysis based on retrieval of only the vertical black-value length from the lower frame B of the binary image data A which has been binarized.

Accordingly, the code reading device 1 of the present embodiment allows specification and reading of a code symbol which is the target of reading by a natural movement, and may improve the operability.

An embodiment of the code reading device according to the present invention has been described above, but the embodiment is not limited to that described above.

In the embodiment described above, the trigger switch is a switch provided to the code reading device 1, but the structure of the trigger switch is not limited to the above.

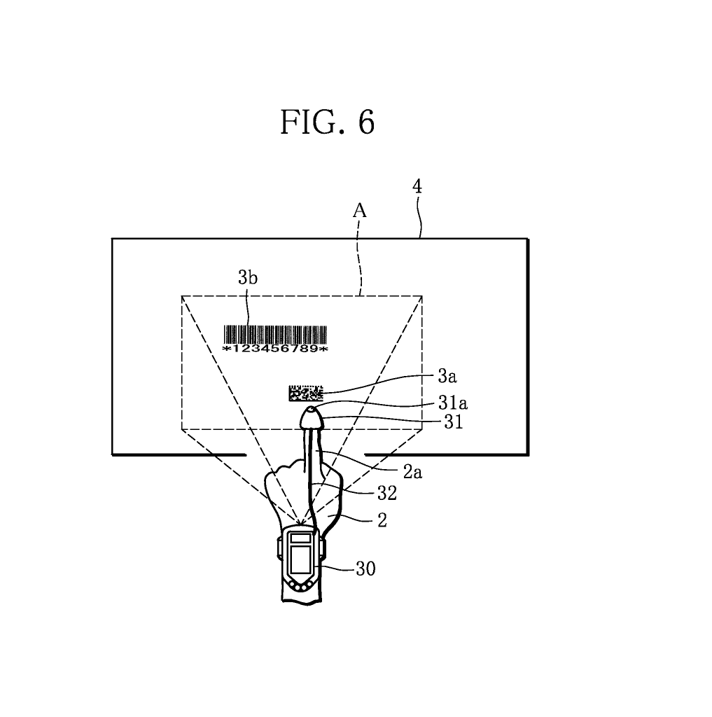

Specifically, FIG. 6 shows an example modification of a code reading device provided with a trigger switch of a different structure. Additionally, in FIG. 6, structures the same as in the embodiment described above are denoted with the same reference signs, and detailed description thereof is omitted.

As shown in FIG. 6, according to a code reading device of the example modification, a trigger mounting tool 31 including a trigger switch 31a is mounted at the tip of the finger 2a of a user. The trigger mounting tool 31 is connected by a wire 32 to the code reading device 30 mounted on the wrist.

The trigger switch 31a provided at the tip of the trigger mounting tool 31 is a push-button which is turned on by being pressed or a proximity sensor which is turned on by being brought close to an object, for example, and starts capturing by the imager unit of the code reading device 30 according to a specifying movement of the finger 2a.

The code reading device 30 configured in the above manner captures an image when the trigger switch 31a of the trigger mounting tool 31 is turned on. Then, as in the embodiment described above, the code reading device 30 detects the fingertip position of the finger 2a within the binary image data which has been binarized, extracts a code symbol near the fingertip position, and performs decoding thereof.

According to this example modification, since the trigger switch 31a is positioned at the fingertip, the specifying movement of the finger 2a and the operation of starting capturing may be performed together, and thus reading of a code symbol may be performed by a more natural movement, and the operability may be further improved.

Additionally, as the trigger switch, a trigger switch that is turned on by audio or the like may be used instead of the one in the example modification.

Furthermore, in the embodiment described above, the code reading device 1 is a wearable code reading device to be mounted on the wrist, but the attachment position of the code reading device is not limited thereto. For example, attachment to the arm or the head of a user may also be allowed.

Moreover, in the embodiment described above, the code reading device 1 detects the finger 2a as the specifying object, but the specifying object is not limited to a finger. For example, application of the present invention in the same manner as the embodiment described above is also possible in the case where a user uses a rod or the like as the specifying object.

Furthermore, in the embodiment described above, the lower frame of the binary image data A is taken as the reference line, and the fingertip position C is detected based on the successive black-value length extending in the vertical direction from the lower frame, but fingertip detection is not limited to be such, and the reference line used for retrieving the successive black-value length may be changed according to the attachment position of the code reading device or the specifying object. For example, the reference line is desirably set according to the mounting position of the code reading device. In the case where the code reading device is mounted on the wrist, on the palm side, the finger normally appears from the upper frame of image data, and thus it is desirable to take the upper frame of the binary image data as the reference line, and to detect the fingertip position based on the successive black-value length extending in the vertical direction from the upper frame.

Moreover, the number of predetermined reference lines for retrieving the successive black-value length is not limited to one. For example, the lower frame of the binary image data A may be taken as a first reference line as in the embodiment described above, and a second reference line that is parallel to the lower frame may be provided within the binary image data A, above the lower frame with a predetermined gap thereto. Also, a third reference line that is parallel to the lower frame may be further provided above the second reference line. By providing a plurality of reference lines in this manner, retrieving the successive black-value length extending in the vertical direction for each reference line, and detecting the finger, the detection accuracy of the finger may be increased. For example, even if black values are partially missing in the binary image data due to light being reflected by the back of the hand, because a plurality of reference lines are provided, there would be at least one reference line that does not include the part where the black values are missing, thus allowing retrieval of the successive black-value length and accurate detection of the finger.

Furthermore, in the embodiment described above, multi-value image data captured by the image capturing camera 21 is binarized, and a fingertip (a specified position) is detected from the binary image data, but the image data to be used for detection of the specified position is not limited to the above. For example, the specified position may be detected by using the multi-value image data without binarization being performed. Also, the specified position may be detected by using a camera capable of capturing binary image data and by using the binary image data captured by the camera.

Furthermore, the code reading device 1 of the embodiment described above has the imager unit 11 and other units installed in one housing, but it is also possible to make only the imager unit wearable, and to provide other units as a separate body connected to the imager unit by a wire or in a wireless manner, for example.

### MODE OF PRESENT INVENTION

A code reading device according to a first mode includes an image capturing unit for capturing an image including a code symbol, a specified position detection unit for analyzing image data captured by the image capturing unit, and detecting a specified position specified by a specifying object within the image data, a code extraction unit for extracting, as a target of reading, a code symbol that is present near the specified position detected by the specified position detection unit, and a code decoding unit for decoding the code symbol extracted by the code extraction unit.

A code reading device according to a second mode is based on the first mode, where the specified position detection unit binarizes multi-value image data captured by the image capturing unit, and detects as the specified position a position of a longest succession of one value corresponding to the specifying object in a vertical direction from a predetermined reference line of the binary image data.

A code reading device according to a third mode is based on the second mode, where the predetermined reference line is a lower frame of the binary image data.

A code reading device according to a fourth mode is based on any one of the first to the third modes, where at least the image capturing unit is mounted on a part of a body of a user by a mounting tool.

A code reading device according to a fifth mode is based on any one of the first to the third modes, where at least the image capturing unit is mounted on a hand or a wrist of a user by a mounting tool, and where the code reading device includes a trigger unit that is to be mounted on a tip of a finger, as the specifying object, of the hand or the wrist where the mounting tool is mounted, the trigger unit being for starting capturing by the image capturing unit according to a specifying movement of the finger.

### EXPLANATION OF REFERENCE SIGNS

1 Code reading device
1a Mounting tool
2 Hand
2a Finger
11 Imager unit
12 Image capturing memory
13 Binary image memory
14 Fingertip detection unit
17 Trigger switch
20 Control unit
21 Image capturing camera
22 Illuminator

1. A code reading device comprising:
an image capturing unit for capturing an image including a code symbol;
a movable specifying object for specifying a target of reading by being brought close to a marginal portion near the code symbol that is the target of reading;
a specified position detection unit for analyzing image data captured by the image capturing unit, and detecting a specified position specified by the specifying object within the image data;
a code extraction unit for extracting, from the target of reading, the code symbol that is present near the specified position detected by the specified position detection unit; and
a code decoding unit for decoding the code symbol extracted by the code extraction unit.

2. The code reading device according to claim 1, wherein the specified position detection unit binarizes multi-value image data captured by the image capturing unit, and detects as the specified position a position of a longest succession of one value corresponding to the specifying object in a vertical direction from a predetermined reference line of binary image data.

3. The code reading device according to claim 2, wherein the predetermined reference line is a lower frame of the binary image data.

4. The code reading device according to claim 1, wherein at least the image capturing unit is configured to be mounted on a part of a body of a user by a mounting tool.

5. The code reading device according to claim 1,
wherein at least the image capturing unit is configured to be mounted on a hand or a wrist of a user by a mounting tool, and
wherein the code reading device includes a trigger unit that is configured to be mounted on a tip of a finger, as the specifying object, of the hand or the wrist where the mounting tool is mounted, the trigger unit being operable for starting capturing by the image capturing unit according to a specifying movement of the finger.

6. The code reading device according to claim 1, wherein in a case where the code symbol cannot be read due to the specifying object overlapping a part of the code symbol that is the target of reading, the code extraction unit performs extraction upon extraction of an entire region of the code symbol becoming possible due to the specifying object being moved.
